(19) United States
(12) Patent Application Publication
(10) Pub. No.: US 2024/0342742 A1
(43) Pub. Date: Oct. 17, 2024

(54) DUAL-ZONE SHOWERHEAD WITH INTERNAL FILTRATION CAPABILITIES

(71) Applicant: David Farley, Corona, CA (US)

(72) Inventor: David Farley, Corona, CA (US)

(21) Appl. No.: 18/134,945

(22) Filed: Apr. 14, 2023

(51) Int. Cl. B05B 15/40; B01D 35/04; B01D 35/157; E03C 1/04

(52) U.S. Cl. CPC B05B 15/40; B01D 35/04; B01D 35/1573; E03C 1/0408; B01D 2201/165; B01D 2201/304; B01D 2201/4061; E03C 2001/026; E03C 2201/40

(57) ABSTRACT

A dual-zone showerhead includes a manifold having an external inlet, an internal outlet, an internal inlet, and first and second outlets. A valve is connected to the manifold and is transitional between first and second positions. In the first position, the valve facilitates fluid communication between the internal inlet and the first outlet. In the second position, the valve facilitates fluid communication between the internal inlet and the second outlet. A filter cartridge is engageable with the manifold and includes a housing having a filter inlet and a filter outlet. The housing is connectable with the manifold to place the filter inlet in fluid communication with the internal outlet on the manifold, and the filter outlet in fluid communication with the internal inlet on the manifold. A flow path extends within the filter cartridge from the filter inlet, through the filtration element, and then through the filter outlet.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a showerhead, and more particularly, to a showerhead having two sprayers and a single integrated filter cartridge configured to filter water flowing through either sprayer.

### 2. Description of the Related Art

Conventional showerheads typically include a sprayer mounted in a generally fixed position on the end of a water line elevated above a shower or tub. This arrangement may allow pressurized water to be directed in a downward direction toward a user to facilitate washing and rinsing of dirt and soap from the user's body. The elevated, generally fixed, position of the sprayer has proven to be useful for many individuals. However, there are some limitations to a fixed sprayer.

One limitation commonly associated with a fixed sprayer is that targeted spraying to certain areas of the user's body may be difficult, particularly lower areas of the user's body. Furthermore, tall individuals may be challenged by the fixed location of the sprayer, as their head may extend above the sprayer, which may require bending of their head to place it within the stream of water. Another drawback is that a fixed sprayer may be challenging for children, as they may be too short to be effectively rinsed by the water pattern created by the fixed sprayer. The water pattern may be too wide by the time it reaches the height of the child, and thus, a large portion of the water may not fall on the child. Fixed sprayers may also be challenging for the elderly or the disabled, who may need to shower in a wheelchair.

In view of these drawbacks, handheld sprayers have been developed, which include a sprayer head attached to a hose extending from a base or hub. The length of the hose provides a range of motion of the sprayer head to address some of the aforementioned deficiencies of fixed sprayers. For instance, the handheld sprayer may be grabbed by a user and moved into close proximity to the area on the user's body in need of rinsing.

In addition to different types of shower sprayers (e.g., fixed and handheld), another feature commonly incorporated into showerheads is a water filter. Many shower filters are formed as cylindrical bodies having cylindrical filter cartridges formed therein. Such shower filters are typically connected at one end to a shower arm and at the other end to a showerhead. While such shower filters are effective in filtering impurities in the shower water, they may suffer from certain limitations. For example, the use of an in-line shower filter in combination with the separate showerhead tends to move the position of the showerhead further into the shower stall to a position that may be less desirable. Additionally, in order to replace the filter cartridge in such an assembly, it may become necessary to disconnect the shower filter body from the shower arm and/or the shower filter, to allow the filter body to be opened in the cartridge to be removed and replaced.

More recently, the functionality of the shower filter in a showerhead has been combined in a single filtered showerhead, where the body of the showerhead may be sized and configured to contain a filter cartridge. Such filtered showerheads provide advantages, such as limiting the extension of the showerhead into the shower. However, such combined filtered showerhead is associated with certain limitations. For example, the filter cartridge may need to be customized in shape to be accommodated within the body, and typically require the filtered showerhead to be disassembled, and/or disconnected from the shower arm before the filter cartridge may be replaced. As such cartridges may be of a more customized shape, they may be more expensive, and more difficult to locate when they need to be replaced.

In view of foregoing, it is desirable to have a showerhead that addresses all of the deficiencies noted above. In particular, there is a desire for a showerhead that incorporates the functionality of a fixed sprayer as well as a handheld sprayer, while also incorporating easy-to-use water filtration capabilities. Various aspects of the present disclosure address this particular need, as will be discussed in more detail below.

### BRIEF SUMMARY

In accordance with one embodiment of the present disclosure, there is provided a dual-zone showerhead having integrated filtration capabilities. The dual-zone showerhead includes a manifold having an external inlet fluidly connectable to a fluid source, an internal outlet in fluid communication with the external inlet, an internal inlet, a first outlet, and a second outlet. A valve is connected to the manifold and is configured to be selectively transitional between a first position and a second position. In the first position, the valve facilitates fluid communication between the internal inlet and the first outlet, and in the second position, the valve facilitates fluid communication between the internal inlet and the second outlet. The dual-zone showerhead additionally includes a filter cartridge selectively engageable with the manifold. The filter cartridge includes a housing having a filter inlet and a filter outlet. The housing is connectable with the manifold to place the filter inlet in fluid communication with the internal outlet on the manifold, and the filter outlet in fluid communication with the internal inlet on the manifold. The filter cartridge additionally includes a filtration element located within the housing. A flow path extends within the filter cartridge from the filter inlet, through the filtration element, and then through the filter outlet.

The valve may be configured such that when in the first position, the valve blocks fluid communication between the internal inlet and the second outlet. The valve may further be configured such that when in the second position, the valve blocks fluid communication between the internal inlet and the first outlet. The valve may be configured to rotate relative to the manifold between the first position and the second position.

The dual-zone showerhead may additionally include a holder coupled to the manifold and configured to detachably engage with a handheld sprayer. The holder may be pivotable relative to the manifold.

The dual-zone showerhead may further include a manifold collar extending around the internal outlet and the internal inlet, the housing being sized to at least partially extend beyond the manifold collar when the housing is connected to the manifold. A cap may be engageable with the manifold, with the cap being configured to at least partially cover the housing when the cap is coupled to the manifold.

The dual-zone showerhead may include a first seal coupled to the housing, with the first seal being engageable with the manifold when the housing is engaged with the manifold to create a water-tight connection between the internal outlet and the filter inlet. The dual-zone showerhead may additionally include a second seal coupled to the housing, with the second seal being engageable with the manifold when the housing is engaged with the manifold to create a water-tight connection between the filter outlet and the internal inlet.

According to another embodiment, there is provided a dual-zone showerhead configured for use with a filter cartridge. The dual-zone showerhead includes a manifold configured to be connectable to the filter cartridge. The manifold includes an external inlet fluidly connectable to a fluid source, and an internal outlet in fluid communication with the external inlet and configured to be fluidly connectable with a filter inlet on the filter cartridge to facilitate fluid communication therebetween. The manifold further includes an internal inlet configured to be fluidly connectable with a filter outlet on the filter cartridge to facilitate fluid communication therebetween, a first outlet, and a second outlet. The dual-zone showerhead additionally includes a valve connected to the manifold and configured to be selectively transitional between a first position and a second position. In the first position, the valve facilitates fluid communication between the internal inlet and the first outlet, and in the second position, the valve facilitates fluid communication between the internal inlet and the second outlet.

According to yet another embodiment, there is provided a filter assembly for use with a fixed sprayer, a handheld sprayer, and an inlet conduit. The filter assembly includes a manifold having a manifold inlet connectable to the inlet conduit to receive water therefrom, and an outlet segment including a first outlet fluidly connectable to the fixed sprayer and a second outlet fluid connectable to the handheld sprayer. A valve is connected to the manifold and is configured to be selectively transitional between a first position and a second position. In the first position, the valve facilitates fluid flow through the first outlet, and in the second position, the valve facilitates fluid flow through the second outlet. A filter cartridge is selectively connectable to the manifold to facilitate fluid communication therebetween. The filter cartridge includes a filter inlet, a filter outlet, and a filtration element. The manifold and the filter cartridge collectively define a flow path wherein water received from the inlet conduit flows sequentially through the manifold inlet, the filter inlet, the filtration element, the filter outlet, and a portion of the outlet segment of the manifold.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a dual-zone showerhead configured in a first mode to dispense water through a fixed sprayer;

FIG. 2 is an upper perspective view of the dual-zone showerhead configured in a second mode to dispense water through a handheld sprayer;

FIG. 3 is an upper perspective view of the dual-zone showerhead configured in a third mode to dispense water through both the fixed sprayer and the handheld sprayer;

FIG. 4 is front perspective view of the dual-zone showerhead;

FIG. 5 is a rear perspective view of the dual-zone showerhead;

FIG. 6 is a side, cross-sectional view of the dual-zone showerhead;

FIG. 7 is an upper perspective view of a valve and a manifold of the dual-zone showerhead, the valve being in a first position associated with the first mode depicted in FIG. 1;

FIG. 8 is an upper perspective view of the valve being in a second position associated with the second mode depicted in FIG. 2; and

FIG. 9 is an upper perspective view of the valve being in a third position associated with the third mode depicted in FIG. 3.

Common reference numerals are used throughout the drawings and the detailed description to indicate the same elements.

### DETAILED DESCRIPTION

The detailed description set forth below in connection with the appended drawings is intended as a description of certain embodiments of a dual-zone showerhead and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

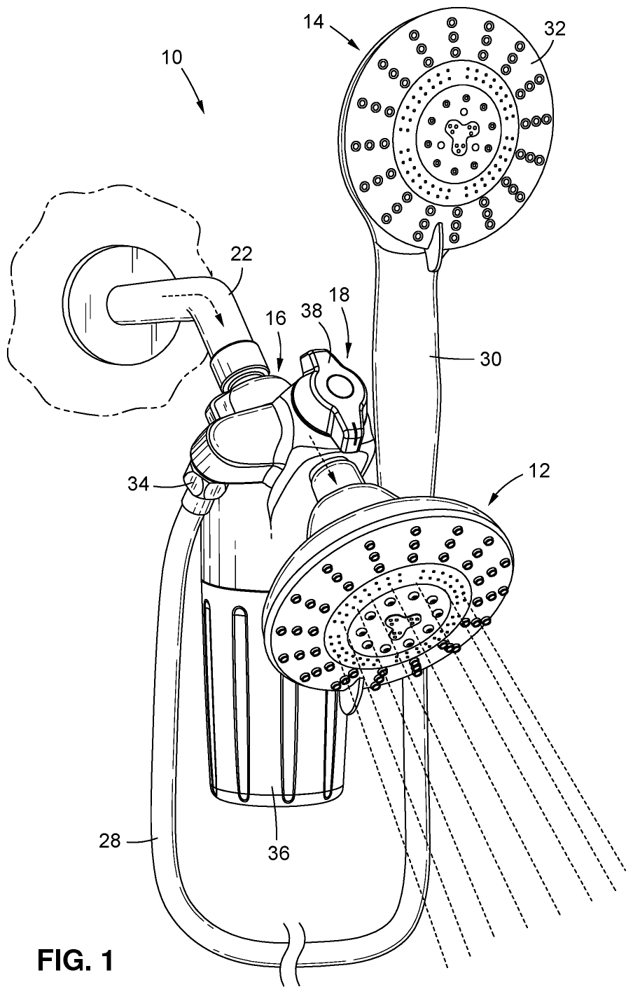

Referring now to FIG. 1, there is depicted a dual-zone showerhead 10 having a fixed sprayer 12 and a handheld sprayer 14, with the ability to selectively transition water flow as desired, either through the fixed sprayer 12 and/or through the handheld sprayer 14. The fixed sprayer 12 and the handheld sprayer 14 are both connected to a manifold 16 having a valve 18 operatively coupled thereto, with the valve 18 being configured to facilitate user control over the path which fluid flows through the showerhead 10.

The manifold 16 includes an external inlet 20 configured to be fluidly connectable to a fluid source 22, such as a pressurized residential water line, to receive fluid therefrom. The manifold 16 also includes a first outlet 24 configured to be fluidly connectable to the fixed sprayer 12 and a second outlet 26 configured to be fluidly connectable to the handheld sprayer 14. The fixed sprayer 12 and the handheld sprayer 14 may both be configured to achieve multiple water patterns based on the position of a movable dial located on the face of each sprayer. The handheld sprayer 14 may also include a hose 28 extending from a gripping wand 30, which in turn, extends from a sprayer head 32. The hose 28 includes an end connector 34 configured to be connectable to the second outlet 26 on the manifold 16 to achieve fluid connection therebetween. The hose 28 provides a flexible range of motion of the handheld sprayer 14 during use.

The manifold 16 may also include a wand holder 35 rotatably coupled to a portion of the manifold 16 (e.g., a main manifold body 37). The wand holder 35 may include a central opening 39 sized to receive an end portion of the gripping wand 30 to retain the gripping wand in place. In this regard, the central opening 39 may be sized and configured to allow for insertion and removal of the end portion of the gripping wand 30 along a holder axis 41 that passes through the central opening 39, while restricting removal of the gripping wand along axes that are offset from the holder axis 41. A slot may extend from the central opening 39 in a direction away from the main manifold body 37 to accommodate the hose 28 when the gripping wand 30 is inserted and removed from the wand holder 35.

The wand holder 35 may be rotatable relative to the main manifold body 37 about a rotation axis 43, which may be perpendicular to the holder axis 41. The rotation of the wand holder 35 about the rotation axis 43 may facilitate angular adjustment of the handheld sprayer 14 when the gripping wand 30 is mounted within the wand holder 35. In one embodiment, the wand holder 35 may swivel approximately 45 degrees between an upright position and a lowered position, with the handheld sprayer 14 being lowered as the wand holder 35 rotates from the upright position toward the lowered position, and the handheld sprayer 14 being raised as the wand holder 35 rotates from the lowered position toward the upright position.

The manifold 16 may also be attachable to a filter cover 36 sized to extend over a portion of an internal filter cartridge, as will be described in more detail below.

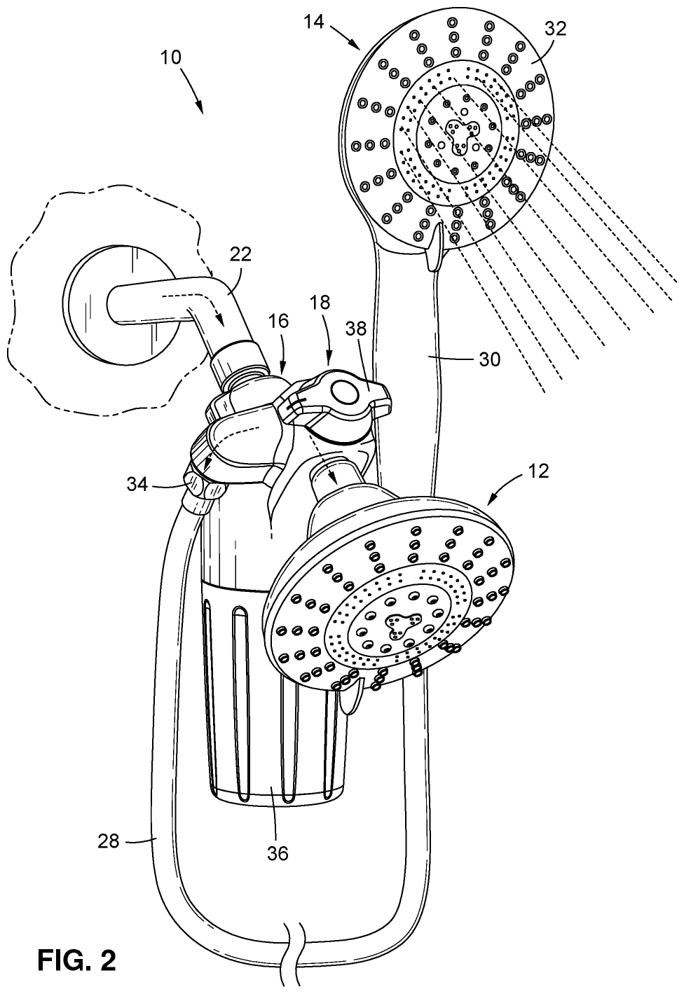

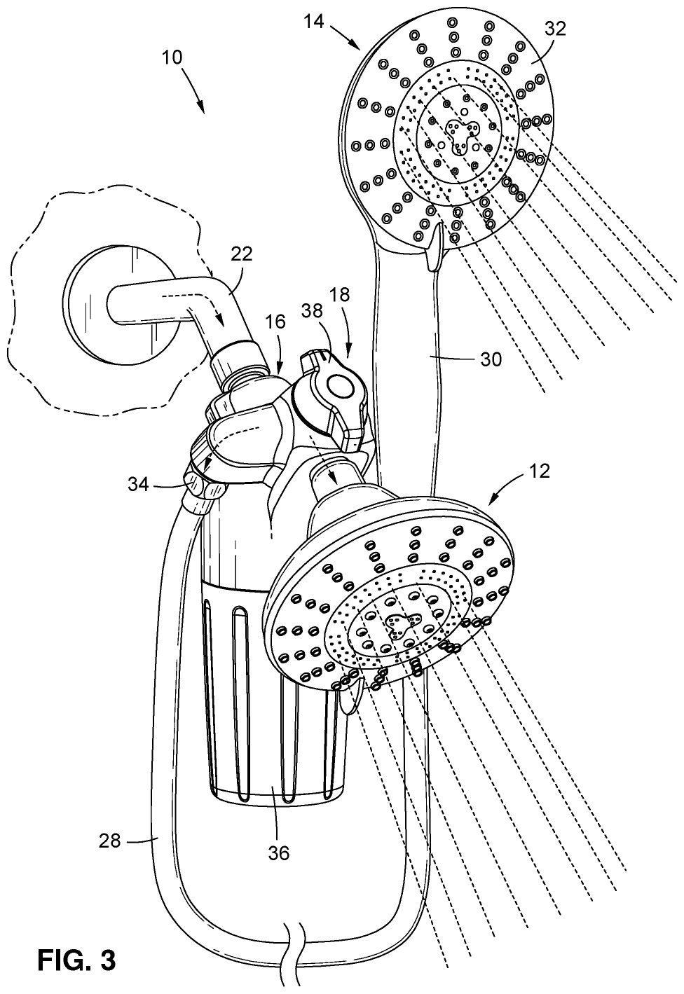

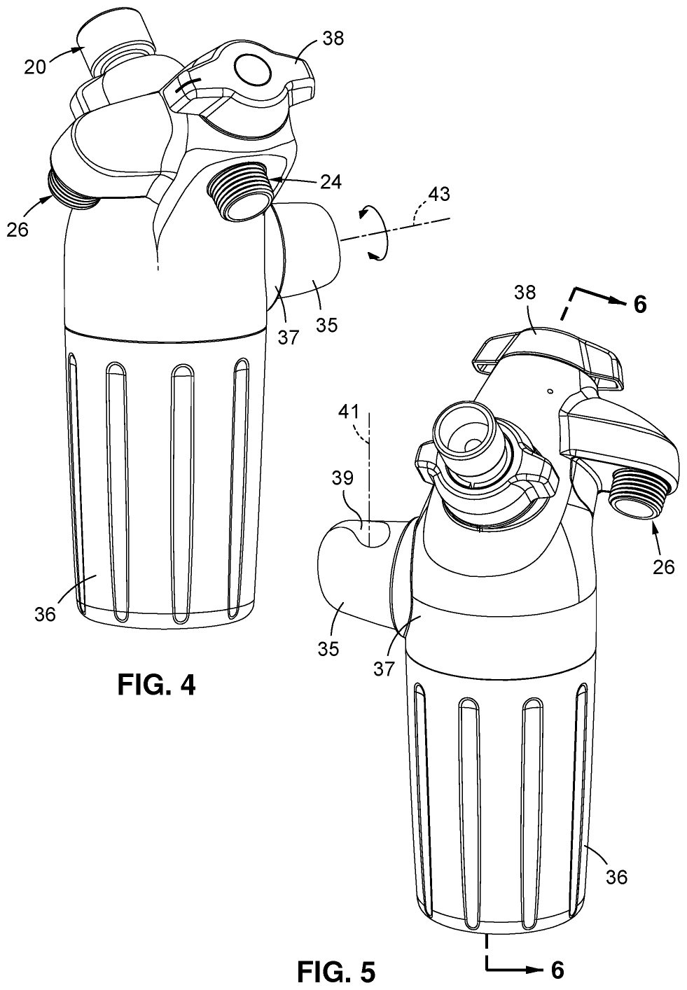

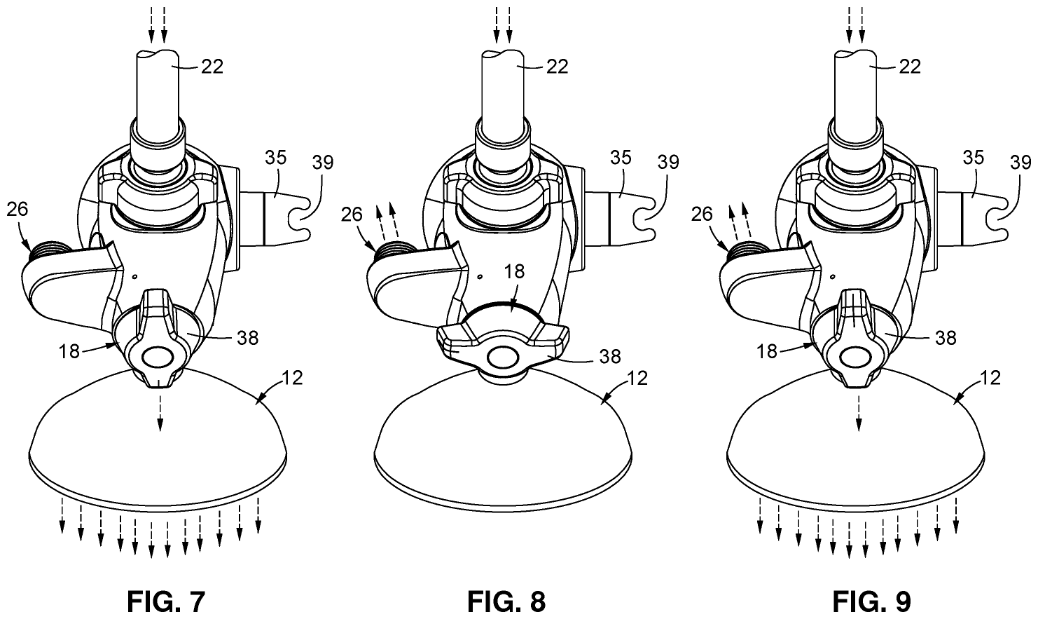

FIGS. 1-3 and 7-9 show the dual-zone showerhead 10 in different modes of operation. In more detail, FIGS. 1 and 7 depict a first mode with water being dispensed through the fixed sprayer 12; FIGS. 2 and 8 depict a second mode with water being dispensed through the handheld sprayer 14; and FIGS. 3 and 9 depict a third mode with water being disposed through both the fixed sprayer 12 and the handheld sprayer 14. The valve 18 includes an external dial 38 coupled to an internal diverter, such that selective rotational positioning of the external dial 38 causes the internal diverter to divert the fluid flow toward a desired outlet, or concurrently to two outlets. In FIGS. 1 and 7, the dial 38 is in a first position, which causes the internal diverter to allow fluid flow through the first outlet 24 and the fixed sprayer 12, while at the same time blocking fluid flow through the second outlet 26 and the handheld sprayer 14. In FIGS. 2 and 8, the dial 38 is in a second position, which causes the internal diverter to allow fluid flow through the second outlet 26 and the handheld sprayer 14, while at the same time blocking fluid flow through the first outlet 24 and the fixed sprayer 12. In FIGS. 3 and 9, the dial 38 is in a third position, which causes the internal diverter to allow fluid flow through the first outlet 24 and the fixed sprayer 12, as well as through the second outlet 26 and the handheld sprayer 14. In one embodiment, the dial 38 rotates approximately ninety degrees between sequential positions, i.e., forty-five degrees between the first and second positions, and another forty-five ninety degrees between the second and third positions. However, those skilled in the art will understand that the scope of the present disclosure is not limited to forty-five-degree intervals, and that any magnitude of angular motion may result in transition between sequential positions. In addition, it is further understood that the showerhead 10 may be configured such the internal diverter is operational in only two modes, i.e., one which facilitates flow through only the fixed sprayer 12, and one which facilitates flow through only the handheld sprayer 14.

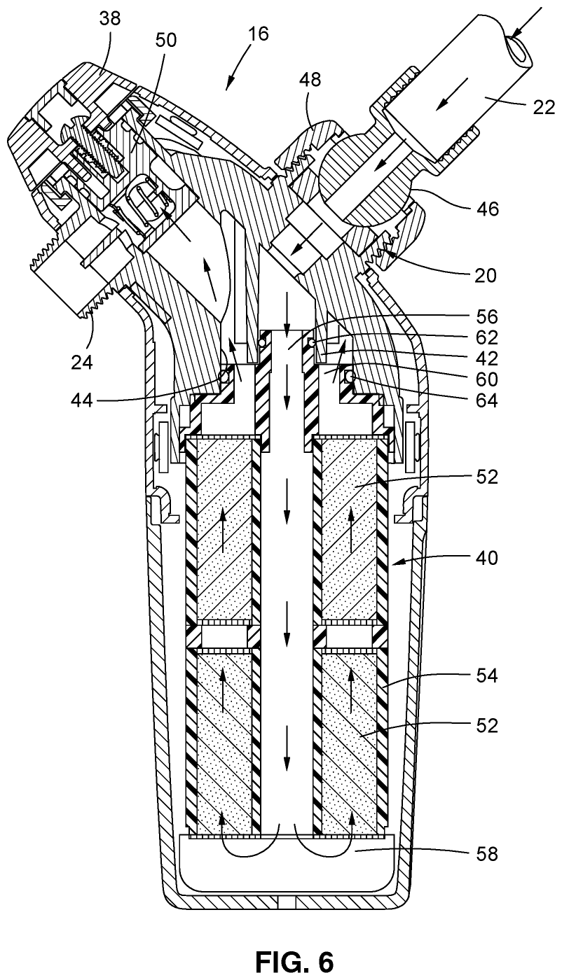

Referring now to FIG. 6, the internal structure of the manifold 16 and filter cartridge 40 will be described below. In greater detail, the cross section depicted in FIG. 6 illustrates the interconnections between the manifold 16, the fluid source 22, and the filter cartridge 40, which may be effectuated via an internal outlet 42 and an internal inlet 44 on the manifold 16. The configuration of the manifold 16 and filter cartridge 40 allows for filtering with only one filter cartridge 40 regardless of whether the water flows through the fixed sprayer 12 or through the handheld sprayer 14, or both. Thus, while the showerhead 10 includes multiple modes of spraying, only a single filter cartridge 40 is needed to filter all water that may be dispensed by the showerhead 10, which allows for a compact, easy-to-use design.

The manifold 16 may be configured to be interconnected to the fluid source 22 and the showerhead 10 via threaded connections. The external inlet 20 may include a threaded connector extending around an opening leading to an internal fluid passageway on the manifold 16. The manifold threaded connector may be configured to engage with a corresponding threaded connector associated with the fluid source 22. As can be seen in FIG. 6, the threaded connector associated with the fluid source 22 may be configured to facilitate a degree of swivel movement of the showerhead 10. A ball 46 may be located at the end portion of the inlet water line, with the ball 46 having a passageway extending therethrough. A threaded collar 48 may be positioned around the ball 46, with the threaded collar 48 having an inner, minimum diameter that is smaller than an outer diameter of the ball 46 to allow the threaded collar 48 to remain on the ball 46. The threaded collar 48 also includes internal threads that are engageable with external threads formed on a projecting portion of the showerhead 10. When the threaded connectors are suitably engaged with each other, fluid communication is achieved between the fluid source 22 and the manifold 16.

The internal outlet 42 of the manifold 16 is defined by an internal cylindrical wall, and the internal inlet 44 may be defined in part by the internal cylindrical wall, and a radially outward wall (e.g., a manifold collar) separated from the internal cylindrical wall. The spacing between the internal cylindrical wall and radially outward wall may result in the internal inlet 44 having an annular configuration disposed about the internal outlet 42. The manifold 16 may include internal flow paths between the internal inlet 44 and the first and second outlets 24, 26.

The internal structure of the filter cartridge 40 may include a filtration element 52 located within the housing 54. The filtration element 52 may be formed from carbon or other filtration materials known in the art. The filtration element 52 may be annular and define an inner diameter and outer diameter. The filter cartridge 40 depicted in FIG. 6 includes a pair of filtration elements 52 in a spaced, stacked arrangement. Along these lines, it is understood that the filter cartridge 40 may include any number of filtration elements 52 without departing from the spirit and scope of the present disclosure. An inner wall may extend along the inner diameter of the filtration element 52, and the housing 54 may extend along the outer diameter of the filtration element 52. The bottom of the housing 54 may include an arcuate surface to promote desired flow characteristics.

The filter cartridge 40 may include an internal flow path having an inlet segment 56 extending from the filter inlet and along the inner wall. The flow path may continue to a diversion segment 58, wherein water may impinge on the arcuate surface and be diverted in a radially outward direction. The flow path may further continue through the filtration element(s) 52, and then through the filter outlet. The water exiting the filter cartridge 40 may enter the internal inlet 44 of the manifold 16.

The filter cartridge 40 may include one or more seals to create fluid-tight engagement between the filter cartridge and the manifold 16. A first seal 62 may be coupled to the housing 54 and configured to be engageable with the manifold 16 when the housing 54 is engaged with the manifold 16 to create a water-tight connection between the internal outlet 42 and the filter inlet 56. The filter cartridge 40 may further comprise a second seal 64 coupled to the housing 54. The second seal 64 may be engageable with the manifold 16 when the housing 54 is engaged with the manifold 16 to create a water-tight connection between the filter outlet 60 and the internal inlet 44.

For more information regarding the filter cartridge 40 and use thereof, please refer to U.S. Pat. No. 11,192,134, entitled Offset Showerhead Filter, the contents of which are expressly incorporated herein by reference.

FIG. 6 also shows the internal diverter 50 of the valve 18, operatively connected to the external dial 38 and in operative communication with the internal passageways of the manifold 16 to selectively route water toward a desired outlet 24, 26, or concurrently to both outlets 24, 26. In this regard, the internal diverter 50 is configured to be placed in a first position to allow fluid flow between the internal inlet 44 and the first outlet 24, while also blocking fluid flow between the internal inlet 44 and the second outlet 26. The internal diverter 50 is also configured to be placed in a second position to allow fluid flow between the internal inlet 44 and the second outlet 26, while also blocking fluid flow between the internal inlet and the first outlet 24. The internal diverter 50 may also be configured to be placed in a third position to allow fluid flow between the internal inlet 44 and the first and second outlets 24, 26.

The filter cartridge 40 may be sized to extend beyond a lower edge of the manifold 16, and thus, one embodiment of the showerhead 10 may include filter cover 36 which is attachable to the manifold 16 and is configured to conceal the filter cartridge 40. The filter cartridge 40 may be threadably engageable to the manifold 16, press-fit engageable to the manifold 16, or detachably engagement through other means known in the art.

It is contemplated that the use of the filter cover 36 may be optional, and thus, certain filter cartridges 40 may be designed to remain exposed when attached to the manifold 16. An aesthetic design may be incorporated into an outer surface of the filter cartridge 40 for filter cartridges 40 designed for use without the filter cover 36.

During operation of the showerhead 10, a user may decide which sprayer 12, 14 to use and turn the dial 38 to the position corresponding to the desired sprayer(s) 12, 14. Once the dial 38 is in place, the user may turn on the water, which causes water to flow into the manifold via the external inlet 20. The water passes through filter cartridge 40 and then flows through the internal inlet 44 of the manifold 16. The internal diverter 50 diverts the water to the desired sprayer(s) 12, 14, and the water is dispensed from the showerhead 10.

The user may adjust the angular position of the showerhead 10 via the swivel connection between the collar 48 and the ball 46. Furthermore, the user may adjust the angular position of the handheld sprayer 14 by rotating the wand holder 35. The handheld sprayer 14 may also be removed from the wand holder 35 and used to achieve more targeted spraying, as may be desired by the user.

The location of the filter cartridge 40 upstream from both the fixed sprayer 12 and handheld sprayer 14 results in all water flowing through the filter cartridge 40, regardless of whether water is directed toward the fixed sprayer 12, the handheld sprayer 14, or both. Thus, showerhead 10 requires a single filter cartridge 40, despite being usable with multiple sprayers 12, 14. Furthermore, the unique configuration of the manifold 16 allows the filter cartridge 40 to be removed and replaced as may be needed with routine maintenance thereof. In this regard, replacement of the filter cartridge 40 does not require disassembly or detachment of any part of the showerhead 10, other than the filter cover 36 (for those embodiments including a filter cover 36). Accordingly, the showerhead 10 provides the benefit of both fixed and handheld sprayers, while also incorporating water filtration capabilities into an easy-to-use and compact form factor.

The particulars shown herein are by way of example only for purposes of illustrative discussion and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A dual-zone showerhead having integrated filtration capabilities, the dual-zone showerhead comprising:
a manifold having:
an external inlet fluidly connectable to a fluid source;
an internal outlet in fluid communication with the external inlet;
an internal inlet;
a first outlet; and
a second outlet;
a valve connected to the manifold and configured to be selectively transitional between at least a first position and a second position, in the first position, the valve facilitating fluid communication between the internal inlet and the first outlet, in the second position, the valve facilitating fluid communication between the internal inlet and the second outlet; and
a filter cartridge selectively engageable with the manifold, the filter cartridge having:
a housing having a filter inlet and a filter outlet, the housing being connectable with the manifold to place the filter inlet in fluid communication with the internal outlet on the manifold, and the filter outlet in fluid communication with the internal inlet on the manifold; and
a filtration element located within the housing;
the filter cartridge having a flow path from the filter inlet, through the filtration element, and then through the filter outlet.

2. The dual-zone showerhead of claim 1, wherein the valve is configured such that when in the first position, the valve blocks fluid communication between the internal inlet and the second outlet.

3. The dual-zone showerhead of claim 2, wherein the valve is configured such that when in the second position, the valve blocks fluid communication between the internal inlet and the first outlet.

4. The dual-zone showerhead of claim 3, wherein the valve is further configured to be selectively transitional to a third position wherein it facilitates fluid communication between the internal inlet and the first outlet concurrently with fluid communication between the internal inlet and the second outlet.

5. The dual-zone showerhead of claim 1, further comprising a holder coupled to the manifold and configured to detachably engage with a handheld sprayer.

6. The dual-zone showerhead of claim 5, wherein the holder is pivotable relative to the manifold.

7. The dual-zone showerhead of claim 1, further comprising a manifold collar extending around the internal outlet and the internal inlet, the housing being sized to at least partially extend beyond the manifold collar when the housing is connected to the manifold.

8. The dual-zone showerhead of claim 7, further comprising a cap engageable with the manifold, the cap being configured to at least partially cover the housing when the cap is coupled to the manifold.

9. The dual-zone showerhead recited in claim 1, further comprising a first seal coupled to the housing, the first seal being engageable with the manifold when the housing is engaged with the manifold to create a water-tight connection between the internal outlet and the filter inlet.

10. The dual-zone showerhead recited in claim 1, further comprising a second seal coupled to the housing, the second seal being engageable with the manifold when the housing is engaged with the manifold to create a water-tight connection between the filter outlet and the internal inlet.

11. A dual-zone showerhead configured for use with a filter cartridge, the dual-zone showerhead comprising:
a manifold configured to be connectable to the filter cartridge, the manifold having:
an external inlet fluidly connectable to a fluid source;
an internal outlet in fluid communication with the external inlet and configured to be fluidly connectable with a filter inlet on the filter cartridge to facilitate fluid communication therebetween;
an internal inlet configured to be fluidly connectable with a filter outlet on the filter cartridge to facilitate fluid communication therebetween;
a first outlet; and
a second outlet; and
a valve connected to the manifold and configured to be selectively transitional between a first position and a second position, in the first position, the valve facilitating fluid communication between the internal inlet and the first outlet, in the second position, the valve facilitating fluid communication between the internal inlet and the second outlet.

12. The dual-zone showerhead of claim 11, wherein the valve is configured such that when in the first position, the valve blocks fluid communication between the internal inlet and the second outlet.

13. The dual-zone showerhead of claim 12, wherein the valve is configured such that when in the second position, the valve blocks fluid communication between the internal inlet and the first outlet.

14. The dual-zone showerhead of claim 13, wherein the valve is further configured to be selectively transitional to a third position wherein it facilitates fluid communication between the internal inlet and the first outlet concurrently with fluid communication between the internal inlet and the second outlet.

15. The dual-zone showerhead of claim 11, further comprising a holder coupled to the manifold and configured to detachably engage with a handheld sprayer.

16. The dual-zone showerhead of claim 15, wherein the holder is pivotable relative to the manifold.

17. A filter assembly for use with a fixed sprayer, a handheld sprayer, and an inlet conduit, the filter assembly comprising:
a manifold having a manifold inlet connectable to the inlet conduit to receive water therefrom, and an outlet segment including a first outlet fluidly connectable to the fixed sprayer and a second outlet fluid connectable to the handheld sprayer;
a valve connected to the manifold and configured to be selectively transitional between a first position and a second position, in the first position, the valve facilitating fluid flow through the first outlet, in the second position, the valve facilitating fluid flow through the second outlet; and
a filter cartridge selectively connectable to the manifold to facilitate fluid communication therebetween, the filter cartridge including a filter inlet, a filter outlet, and a filtration element;
the manifold and filter cartridge collectively defining a flow path wherein water received from the inlet conduit flows sequentially through the manifold inlet, the filter inlet, the filtration element, the filter outlet, and a portion of the outlet segment of the manifold.

18. The filter assembly of claim 17, wherein the valve is configured such that when in the first position, the valve blocks fluid communication between the internal inlet and the second outlet.

19. The filter assembly of claim 18, wherein the valve is configured such that when in the second position, the valve blocks fluid communication between the internal inlet and the first outlet.

20. The filter assembly of claim 19, wherein the valve is further configured to be selectively transitional to a third position wherein it facilitates fluid flow through the first outlet and concurrently facilitates fluid flow through the second outlet.
